(19) United States
(12) Patent Application Publication
(10) Pub. No.: US 2006/0273507 A1
(43) Pub. Date: Dec. 7, 2006

(54) Educational Battle Game And Method Of Teaching The Periodic Table Of The Elements

(76) Inventors: Timothy Jon Pelzel, Lakeport, CA (US); Andrew Alan Leach, Nice, CA (US)

Correspondence Address: STAINBROOK & STAINBROOK, LLP, 3558 ROUND BARN BLVD., SUITE 203, SANTA ROSA, CA, 95403, US

(21) Appl. No.: 11/422,046

(22) Filed: Jun. 2, 2006

Related U.S. Application Data
(60) Provisional application No. 60/687,187, filed on Jun. 3, 2005.

(51) Int. Cl. A63F 1/00; G09B 19/22; A63F 3/00; G09B 23/26

(52) U.S. Cl. 273/236; 273/302; 273/243; 434/282; 434/128

(57) ABSTRACT

An educational battle game and method for teaching the elements of the periodic table of the elements. It can be played with physical cards or, alternatively, with the data from the periodic table in various media, combined with game-specific terminology and characters.

### RELATED APPLICATION

This application claims priority based upon U.S. Provisional Patent Application Ser. No. 60/687,187, filed on Jun. 3, 2005.

### TECHNICAL FIELD

The present invention relates generally to games, more particularly to educational games, and still more particularly to an educational battle game method of teaching the periodic table of the elements. It can be played with physical cards or, alternatively, with the data from the periodic table in various media, combined with game-hyphen specific terminology and characters.

### BACKGROUND ART

In any classroom where chemistry is taught, and in any laboratory or industry where chemistry is practiced, one will almost invariably find a large chart displayed on the wall—the periodic table of the elements. This chart is one of the marvels of visual scientific information, and it contains in a very concentrated space a wealth of information about all the elements known and their relationships to one another. However, it is also the density of information that makes the details of the periodic table challenging to master and remember.

It is well known to provide entertaining teaching devices to teach science. Some might argue that the trend toward making education entertaining is actually compromising the educational process, but most of that criticism is directed at teaching vehicles in which information is delivered to a passive child or student, entertaining educational television being the most common object of such criticism. Interactive educational teaching devices that are entertaining and that fully engage the student's senses, however, are heralded as providing the optimum teaching vehicle. Accordingly, a significant investment of time, energy, and money has been made in developing pedagogical games. The list is too replete to set out.

In recent years role-playing and battle card games have become increasingly popular. Among the patents showing battle game methods include, exemplary patents include:

U.S. Pat. No. 6,601,851 to Sakamoto, et al., issued Aug. 5, 2003, which teaches a card game toy that includes a master card as an alter ego of a player and a plurality of monster cards. It is used in a battle card game by placing it as well as opponents cards in positions on a field of battle. The master card includes a character display portion to display a character, an ability-reducing indication to indicate an ability to reduce the attack power from the opponent, and a card-hand-ability indication to indicate an ability to use a card hand. The monster card includes a character display region to display a character, a position indication indicative of whether of a forward type or backward type, a physical-power indication indicative of a physical-power of the monster, and an ability indication indicative of an ability of the monster.

U.S. Pat. No. 5,954,332, to Mero, et al., issued Sep. 21, 1999, discloses a role playing dual board game for a plurality of players in which a series of class games are played to determine class winners, then a final game is played in which the class winners unite to battle against a final opponent. The present invention comprises a random number generating device such as dice, and a plurality of game cards. Each of the game cards comprises a plurality of numeric ranges such that the roll of the dice can dictate the relative utility of that individual playing card. In addition, the invention comprises a plurality of class game boards and a single final game board, each of said boards having a first and second side. Each of the class game boards is used to determine a class winner while the final game board is used by the class winners to unite in a final battle against the final opponent. In accordance with the above, it is an object of the present invention to provide a role playing game in which class winners unite to play against a final opponent.

U.S. Pat. No. 5,951,013, to Campanella, issued Sep. 14, 1999, shows a card battle game of chance and strategy involving nature's elements. The device includes a plurality of nature cards including elements of fire, earth, metal, water and wood wherein fire destroys metal, metal cuts down wood, wood covers earth, earth absorbs water, and water puts out fire. A plurality of advanced cards are also provided. The advanced cards include force of nature, chaos, and anger of the gods wherein the force of nature counters any nature card, the chaos card counters the force of nature card or forces the removal of any nature card, and the anger of the gods card destroys all nature cards in play.

Several patents include novel methods of deploying character cards in a battle game. For instance, U.S. Pat. No. 6,554,702, to Mahar, et al., issued Apr. 29, 2003, teaches a card game of chance and strategy and allows for cards to become collectible, some of which are provided as rare cards of special appeal. Key rules of the game, such as the flow render the game a real time card game in which plays are made, not by turn, but by a mechanism that involves the elements of chance, strategy and players' abilities. The power, effectiveness and functionality of cards can dynamically change.

U.S. Pat. No. 6,322,077, to Braunlich, et al., issued Nov. 27, 2001, discloses a method of deploying character cards by divided character cards into two groups. One group of character cards includes all the common cards. The common cards represent characters that there are “lots of” in a universe. A second group of character cards includes all the unique character cards. A unique character card may be stackable. A unique character card that is stackable indicates that multiple copies of that unique character card may be used in a particular fight, mission, location or any other event, depending on the particular card game. Alternatively, the common character cards may be stackable. Further, all cards in a playing deck of cards may be stackable, as is desirable, to control the use or deployment of the cards.

The foregoing patents and prior art devices reflect the current state of the art of which the present inventor is aware. Reference to, and discussion of, these patents is intended to aid in discharging Applicant's acknowledged duty of candor in disclosing information that may be relevant to the examination of prospective claims to the present invention. However, it is respectfully submitted that none of the above-indicated patents disclose, teach, suggest, show, or otherwise render obvious, either singly or when considered in combination, the invention described herein. Specifically, no known game in the prior art teaches a battle game method of teaching science of any kind, nor especially for teaching the periodic table. Accordingly, the present invention provides such a method and the apparatus to practice the method.

### DISCLOSURE OF INVENTION

The present invention satisfies the needs stated above. The present invention is generally directed toward an educational game. More specifically, the present invention is directed toward an educational battle game method of teaching the periodic table of the elements.

An aspect of the physical components of the inventive game includes a plurality of element character cards. Each element character card represents one element of the periodic table. Further, each card incorporates actual data relating to the specific periodic table element thereon. This data can include the atomic number and ionization potential for the periodic table element associated with each card.

Further, a game board can be utilized to enhance game play. This game board can include a number of card spaces for placing one or more element character cards during game play. Examples of the card spaces include elemon start spaces, mole discard pile spaces, compound attack combo spaces, triumphant element card spaces, earned mole card spaces, strategic play set spaces, liberated elemon spaces, and mole play spaces.

Additionally, a randomizer can be added to the game play to add an element of chance to the game play. This randomizer can be selected from coins, dice, or cards alone or in combination. An example of the randomizer cards includes a mole card that has specific game play instructions.

An aspect of the element character cards includes having a character display region to depict a figure representing a character and a character attribute region to depict the attributes associated with the character. The character's attributes include various character power information along with the actual data associated with the period table element that is represented on the card.

An aspect of the method for playing the inventive educational card battle game includes providing a plurality of element character cards to each of the players then applying game rules to determine the winner. Each element character card includes a drawing of a character that represents one element of the periodic table representing an element of the periodic table and incorporating actual data relating to the specific periodic table element thereon.

The rules for comparison can be varied. A first aspect can include comparing the actual phase of the matter at a specific temperature setting for the periodic table element represented on each card. The phases of matter include solid, liquid and gas. Once such set of rules could indicate that the element character card having phase of matter being gas triumphs over a liquid phase of matter element, a liquid phase of matter element triumphs over a solid phase of matter, and a solid phase of matter triumphs over a gas phase of matter, or any other combination thereof. If two cards have the same phase of matter, the comparison can be made from other actual data, such as a phase of matter comparison at a second temperature or a comparison of the crystalline structure of each represented element.

To add an aspect of chance and uncertainty to the game, a randomizer in the form of a mole card can be used. Each mole card has game specific instructions. These instructions supersede all other normal game play rules. Typically, a mole card can only be used once, but it is within the scope of the present invention that the number of uses a mole card can be used can be determined by the players.

A second aspect for the game play rules includes employing the plurality of attack formulations from one element character card to reduce the injury points of an opposing element character cards. The value of injury point per card reflects the ionization potential for the periodic table element represented on each card. In turn, the opposing player can utilize a defense to reduce the impact of the attack formulations. The players rotate turns until a card has had its injury points reduced to zero. Play continues for all cards.

One aspect of using an attack formulation includes using a randomization aspect to the attack formulations. This randomization aspect can include the use of dice, coins and cards, individually or in combination.

A third aspect for the game play rules includes each player employing two or more of element character cards to create a combination. This combination is based on actual combinations by the actual periodic table elements. A randomization aspect can also be included in this aspect of the game play rules.

Many other beneficial results can be attained by applying the disclosed invention in a different manner or by modifying the invention within the scope of the disclosure. Accordingly, other objects and a fuller understanding of the invention in addition to the scope of the invention are set forth in the detailed description of the preferred embodiments and as illustrated by the accompanying drawings.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views.

FIG. 1 is a top plan view of the preferred embodiment of the game board for use with the inventive method;

FIGS. 2-4 are exemplary “elemental” character cards.

FIG. 5 is a flowchart of an embodiment 500 of the inventive method for teaching the periodic table of the element.

FIG. 6 is a flowchart of an embodiment 600 of the rules as applied in the inventive method for teaching the periodic table of the element.

FIG. 7 is a flowchart of an additional embodiment 700 of the rules as applied in the inventive method for teaching the periodic table of the element.

FIG. 8 is a flowchart of an additional embodiment 800 of the rules as applied in the inventive method for teaching the periodic table of the element.

### BEST MODES FOR CARRYING OUT THE INVENTION

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims. The invention is capable of other embodiments and of being practiced or carried out in a variety of ways. It is to be understood that the phraseology and terminology employed herein are for the purpose of description and not of limitation.

In the following detailed description, the following definitions of novel terms are employed:

“Elemontals”—an embodiment of the present invention utilizing the components, as shown in the drawings and described in this detailed description, in which players attempt to win by using cards based on the periodic table of the elements by the accumulation of more successful (triumphant and victorious) elemon, individually or in combination with other elemon to score the most points. This embodiment uses various learning and mnemonic techniques as a method of teaching the principals of general science, the period table of the elements, atomic properties, and the basic terminology and concepts of physics and chemistry. This embodiment is also a form of recreational entertainment independent of its educational value and techniques, which further enhances its teaching potential.

“Elemon”—refers to an elemontal's cards and card characters, including all the characteristics and attributes of the characters as indicated on the card; each elemon is associated with only one element in the periodic table.

“ATN”—a number based on the atomic number of respective elements in the periodic table that can be used to determine the order of attack sequences. ATN is the abbreviation for attack number.

“Attack number”—a number based on the atomic number of respective elements that can determine the order of attack sequences.

“IP”—a number based on the 1st ionization potential of respective atomic elements used in the present inventions to determine how much injury energy an elemon can sustain before being “liberated.” “IP” in the game stands for injury points.

“Injury points”—a number based on the 1st ionization potential of respective elements used to determine injury (reduction to IP) an elemon can sustain before being liberated.

“Electro-shield”—a fictitious shield based on the valence electron shells of respective atoms that allow the elemon to mitigate “damage” (reductions to their IP). Abbreviated “ES.”

“Damage”—a reduction to an elemon character's IP.

“Liberated”—a term applied to an elemon that is not triumphant or whose IP reaches zero. Liberated Elemontals cards are placed on the player's liberated elemon space.

“Triumphant elemon”—an elemon which advances from a first to a second phase of an embodiment of the present invention.

“Elemon base pile”—the Elemontals cards that a player holds at the beginning of play.

“Mole hill”—also known as the “mole play” card space on the game board; the starting space for the mole cards if mole cards are to be used in the game.

“Mole hole”—the space on the game map for earned mole cards if mole cards are to be used; also, the “mole discard pile” card space on the game board.

“Melting pot”—a cardspace onto which Elemontals cards are played in an embodiment of present invention.

“Order”—a battle is considered to be in order when the player holding the card with the lowest ATN decides to use attack equations in the exact order (read from top to bottom) in which they are listed on the cards.

“Chaos”—a battle is considered to be in chaos when the player holding the card with the lowest ATN decides that the property attack equations may be used in any order, as long as each attack equation is used only once before each of the others are used.

“Microindo”—a term to describe the imaginary window “scienaughts” look through to see the imaginary actions and events of the elemon characters in the microindojo space in the game.

“Micrindojo”—a space into which Elemontals cards are played in an embodiment of the present invention.

“Victorious elemon”—a term used to describe a card which advances during the course of play.

“Mole card”—an optional card which contains specific instructions for its play.

“Mole discard pile”—a card space where mole cards are placed after use.

“Mole play space”—a card space where optional mole cards are to be played.

“Ligaso”—a name for an embodiment of a phase of play of the present invention.

“Table phase”—a term for an embodiment of a phase of play of the present invention.

“Final conflict”—a term a name for an embodiment of a phase of play of the present invention.

“Attack equations”—an equation using variables to prescribe potential values for various “property” attacks. The variables include the top dice number range value, and the “EC” and “FM” variables. Occasionally, attack equations may contain another game-specific variable, such as ATN.

“Property attack”—this term describes the various imaginary attacks of Elemontals characters based on the actual properties and real world uses of the base element of the elemon character, but sometimes based simply on the elemon character itself.

“Top dice number range value”—a range of numbers consisting of a range of 2 to 6 numbers in sequence from lowest to highest. The top dice range value uses the first and last numbers in the range, respectively separated by the preposition (to). The range is determined by the attack equation, the value is determined with a six-sided die roll or a spinning dice called a top dice, which may be spun instead of being rolled like a traditional die, as per the rules.

“Top dice”—a special six-sided die that may be spun like a top, or rolled like a traditional dice.

“Electro-coins”—two sided disks with a + sign on one side and a − sign on the other, flipped to determine the EC variable for attack equations. Electro-coins are also flipped to determine electro-shield value, and sometimes to determine if or how an event during game play takes place. Regular coins may be substituted in place of actual game electro-coins. Heads results are recorded as +, tails are recorded as minus.

“+EC”—this indicates an electro-coin toss must take place. If the result is a plus (+), the action takes place. If this part of an attack equation, one (1) is added to the + result.

“−EC”—this indicates that an action takes place in the game if the result of an electrocoin toss is a minus (−). If this is part of an attack equation, one (1) is subtracted from the result.

“+−EC”—this indicates that one of two game actions will take place based on whether an electrocoin toss results in a plus (+) or a minus (−). If this is part of an attack equation, one is added to the result if the result is a plus (+), and one is subtracted from the result if the result is a minus (−).

“Faction Monifier”—a chart used to determine the faction monifier (FM) variable for attack equations and faction fratematies, based on the series of the periodic table.

“Scienaught”—a player of the present invention. There are four different levels of scienaughts (players).

“Scienate”—a beginning player of the present invention.

“Sciemate”—an intermediate player of the game.

“Scielate”—a master player of the game.

“Oscie”—A teacher of the game play of the present invention.

“Master Oscie”—a player who has reached a prescribed number of victories in tournament play.

“Liberated elemon space”—a card space where liberated Elemontals cards of the respective scienaught are placed. The liberated elemon space is further delineated in the game map.

“Game map” (also “game board”)—a game mat for use during game play.

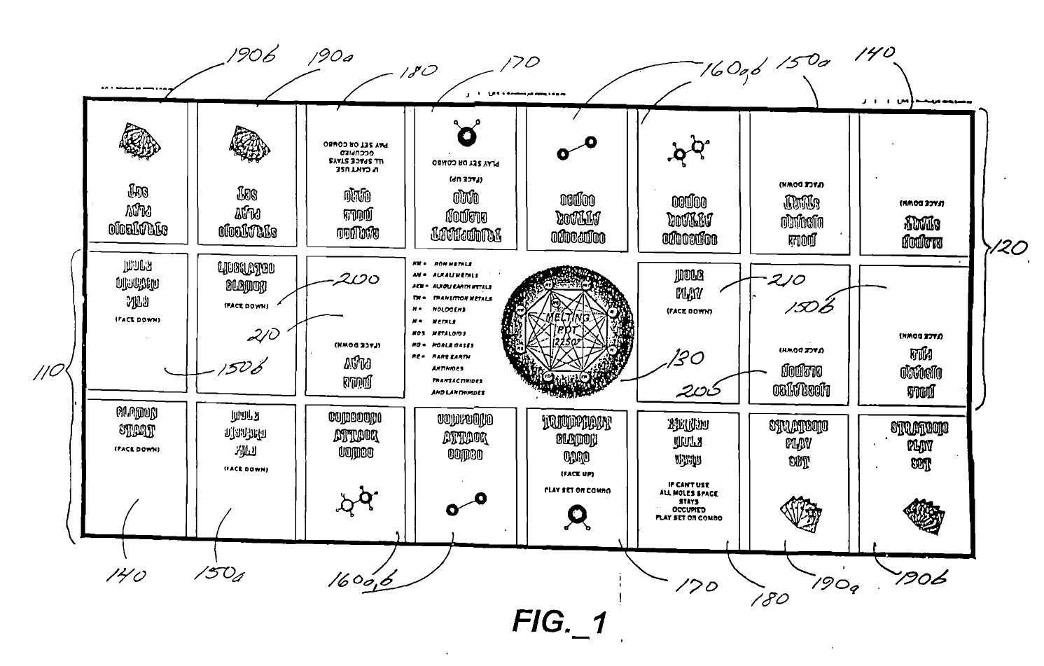

Referring to FIGS. 1 through 4, wherein like reference numerals refer to like components in the various views, there is illustrated an embodiment of the inventive educational battle game for teaching the periodic table of the elements. The game pits the knowledge and strategies of each player against the knowledge and strategies of opponents.

In this embodiment, the physical components of the inventive game include a game board and a plurality of element character cards. FIG. 1 illustrates a first embodiment of the board that may be employed in the inventive game. This view shows that the board 100 preferably includes a game map having a first side 110 and second side 120, symmetrical around a center portion 130 known as the melting pot. Each side includes a plurality of card spaces upon which game cards can be laid, including elemon start spaces 140, mole discard pile spaces 150, compound attack combo spaces 160a, 160b, triumphant element card spaces 170, earned mole card spaces 180, strategic play set spaces 190, liberated elemon spaces 200, and mole play spaces 210.

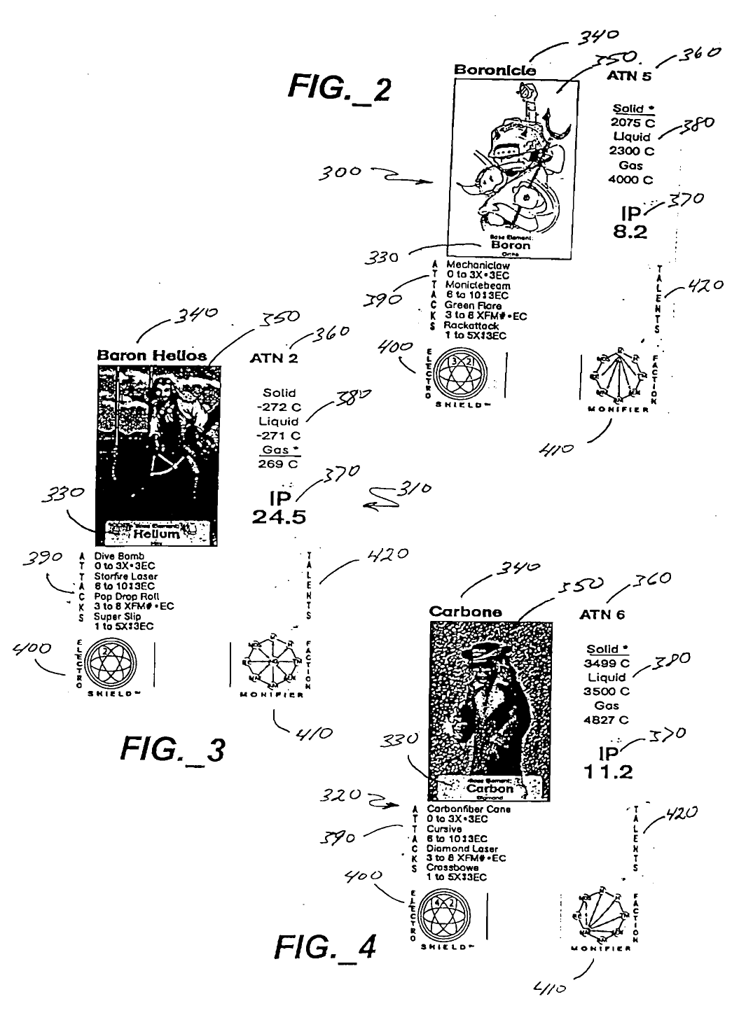

Referring next to FIGS. 2-4, embodiments of exemplars of the collection of element character cards are illustrated. Each includes an ornamental but generic first side (not shown) and an informational element character side, as depicted in each of FIGS. 2-4. The information and character depicted on each card is based on an element in the periodic table. For example, FIG. 2 shows a card 300 based on the element boron. FIG. 3 shows a card 310 based on the element helium. FIG. 4 shows a card 320 based on the element carbon. In fact, for didactic and mnemonic purposes, the element is expressly identified by name in the element name portion 330. The cards further include an elemon name 340, an elemon image 350, a designation of the ATN 360, an indication of the IP 370, a phase indicator portion 380 which defines the state of matter in which the base element occurs at the melting pot temperature, and at room temperature an Attack Equation table 390, an electro-shield indicator 400, a Faction Monifier chart 410, and a talent list 420.

Another embodiments of the physical components of the inventive game include the game board and the plurality of element character cards set out above along with one or more randomizer devices (not shown), such as one or more dice, coins, or cards. These randomizer devices can be used individually or in combination.

An embodiment of the coin-style randomizer is referred to as a collectable coin. This coin serves the dual purpose of being collectable in that it has various information relating to specific elements of the periodic table along with graphical representations of characters; along with giving the player an advantage during game play. For example, if the player is holding the Hydrogen collectable coin and the element character card representing Hydrogen, that player may be able to have a second coin toss if desired.

An embodiment (not shown) of the randomizer in the form of a card can be referred to as a “mole card.” This card has specific information thereon that affects the play of game.

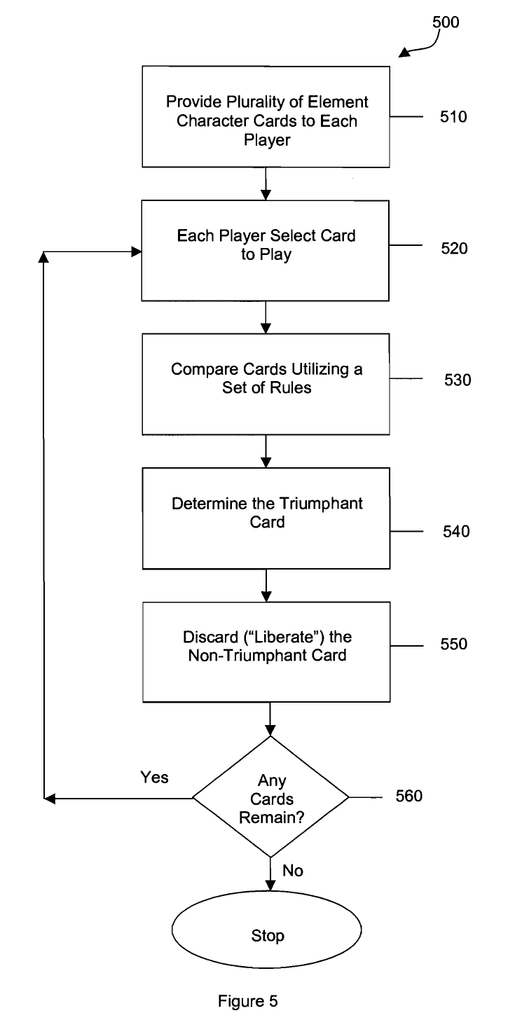

Referring now to FIG. 5, there is illustrated an embodiment 500 of the inventive educational battle game method for teaching the periodic table of the elements. This embodiment 500 allows for a player to utilize his raw ability, skills, strategies, and a little luck in an attempt to win the game by using his element characters cards to outscore his opponent and his element characters cards.

This embodiment provides that a plurality of element character cards, as previously discussed, are provided to each player 510. Each player then selects one card 520 and compares it to the cards selected by the other player or players 530. A set of rules determines which card is triumphant over the other card or cards. All non-triumphant cards are discarded, or in the vernacular of the periodic table, they are liberated 550. The comparison of the cards continues until all element character cards have been used 560. The winner is the player with the most cards at the end.

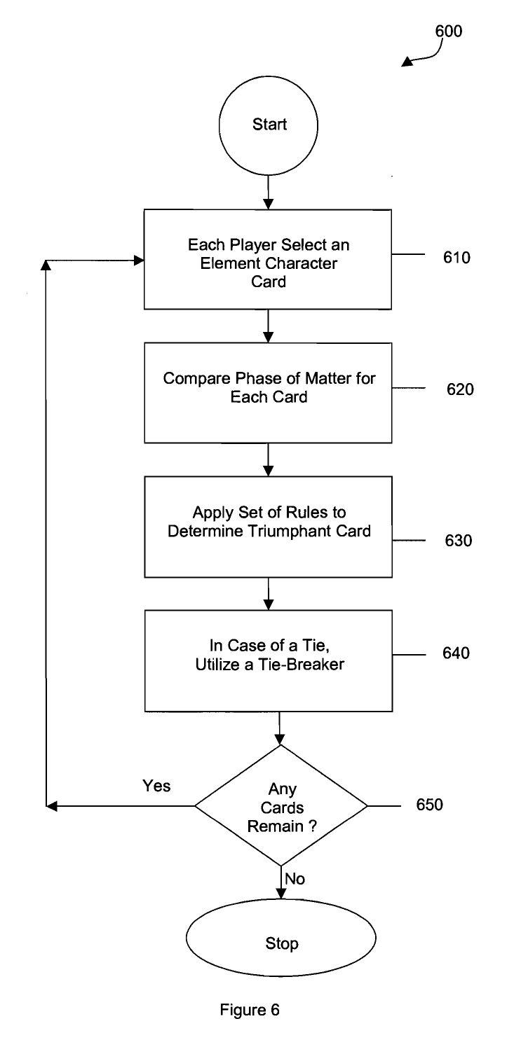

Referring to FIG. 6, an embodiment 600 of the set of rules is illustrated. Embodiment 600 provides that the actual data included on each element character card includes a graphical representation of the actual phase of matter at specific temperature settings for the periodic table element represented by each element character card. These phases can include being a solid, liquid and gas. After each player selects an element character card 610, the phase of matter at specific temperature settings, such as 1400 C for the periodic table element represented by each element character card is compared to the other selected cards 620. Depending the phase of matter, a card may be triumphant or non-triumphant 630.

One such comparison includes where a gas phase of matter triumphs over a liquid phase of matter, and where a liquid phase of matter triumphs over a solid phase of matter and where a solid phase of matter triumphs over a gas phase of matter.

In the event where two or more cards have the same phase of matter, a tie breaking procedure can be employed 640. One such tie-breaker employs a second phase of matter comparison can be made, but only at a second temperature setting, such as room temperature.

Another tie-breaker employs a comparison of each element's crystalline structures. The crystalline structure hierarchy is listed in order of superiority. For example, the number 1 structure is superior to all others. The number 2 structure is superior to numbers 3 and up. Thus, the lower number on the list of the crystalline structure hierarchy. Examples of the crystalline structure hierarchy include: diamond, ortho, rhombo, tetra, hex, complex, cube and mono. Play continues until all character cards have been compared to determine the triumphant cards.

To add an element of unpredictability, a randomizer in the form of a card, referred to as a “mole card,” can be used. This card has specific information thereon that affects the play of game. This specific information supersedes all other contradictory game rules.

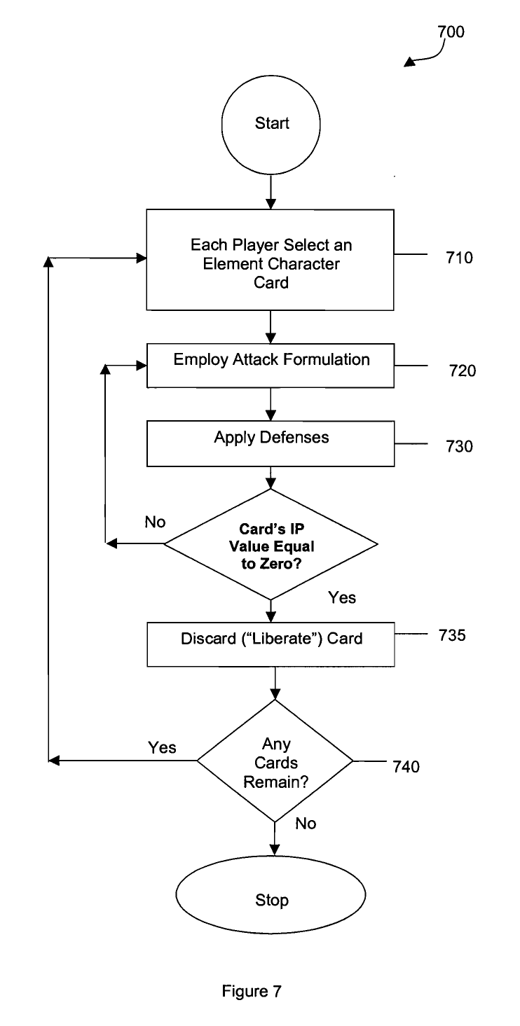

Referring to FIG. 7, an embodiment 700 of the set of rules is illustrated. Embodiment 700 provides that the actual data includes the actual atomic number, ionization potential and valance for the periodic table element represented by each element character card. Further, each element character card has a plurality of attack formulations and a plurality of defenses located thereon. The injury point value for the character displayed on each card is actually the ionization potential for the represented periodic table element.

After each player selects an element character card 710, the first player employs one of the attack formulations located on that card to reduce the injury points from one element character card of the other player. The other player is able to reduce the impact of the attack formulation by using a defense 720. The defensive power is based on the card's electroshield values, which are based on the card's represented periodic table element's valance. The players exchange attacks and defenses until one of the character's injury points are reduced to zero 730. At this point, card that has zero injury points is discarded and is considered to have been liberated. Game play continues for all of the player's cards. 740.

An embodiment of applying an attack formulation can include the use of one or more randomization devices such as dice, coins and/or card, individually or in combination. These devices are used to obtain the damage number that is then subtracted from the opposing card's injury points. The opposing player is able to use one of the electroshield values in combination with one or more of the randomizing devices to determine a value that absorbs part or all of the attack value.

An example of an attack formulation is as follows. The formulation has two basic parts. The first part is a number range value represented by one die referred to as a “Topdice™” or “T-Bone™”. The sides of the die have a “T-Bone”, “T-1”, “T-2”, “T-3”, “T-4” and “T-5” thereon. The second part is represented by a number of electrocoins, a coin having a “plus” on one side and a “negative” on the other. An exemplar of the formula reads 6 to 10+OOO. One die is rolled and three electrocoins are rolled. The die covers the 6 to 10 range value. The die has 6 sides and for this range would read: T-Bone=10 (highest value in the range), T-1=9, T-2=8, T-3=7, T-4=6, T-5=6. The T means top range value with the minus number subtracting from that on a T-#. In this example T-4 and T-5 have the same value because the bottom of the range is listed as 6 (you can't go any lower than the bottom value of the listed range). If a “T-3” is rolled, the first part value is 7.

The three electrocoins are rolled and only the “pluses” are counted. If out of the three coin flips, two are “pluses” and 1 is “negative”, then the second part value is 2. The final damage number is thus 9.

An example of a defense is as follows. The opposing player flips the electrocoin the number times equal to one of the character's electroshield numbers. The number of “negatives” are counted. This number is used to reduce the attacking player's damage number. For example, if the electroshield number is 2, the opposing player flips the electrocoin two times. If both flips are negative, the defense number is 2. Subtracting this amount from the attacking player's damage number, the overall damage number is 7, i.e. 2 removed from 9.

As with the prior embodiment of the rules, a mole card can also be used to add an additional aspect of randomness to the game play. Further, other types of attack play can be utilized, such as utilizing the group affiliation for the represented periodic table element on each card. One skilled in the art will appreciate that the above is merely illustrated and not meant to be limiting.

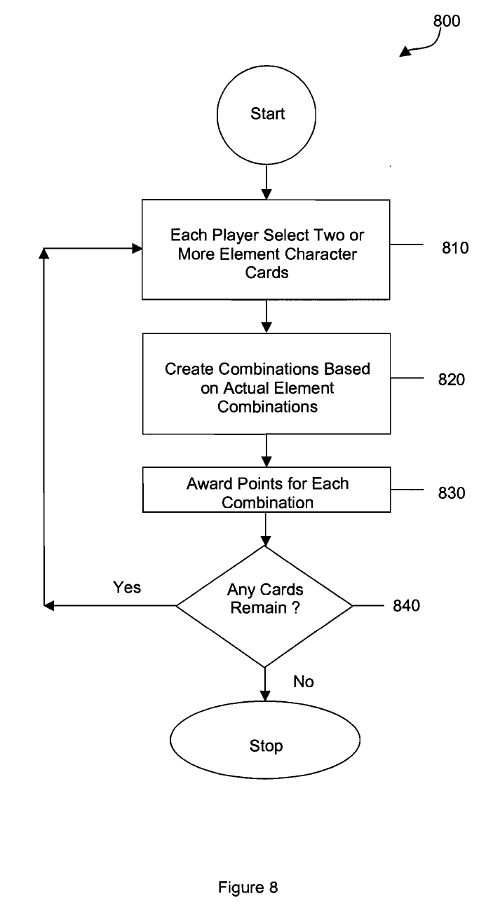

Referring to FIG. 8, an embodiment 800 of the set of rules is illustrated. Embodiment 800 provides that each player employs two or more of the player's plurality of element character cards to create a combination based on the actual data contained in those selected cards. Various amounts of points are awarded for the different types of combinations produced. The player with the most points is the winner. Additionally, the use of a coin or dice can be used to augment the calculation of the points.

Examples of the combinations include combining those element character cards that form an alloy. For example, if a player has the element character cards representing the aluminum (Al) and lithium (Li) to form the alloy AlLi. Another combination can be of a faction combination, that is a series of cards from the same faction of the periodic table. For example, three element character cards from the Non-Metals Faction can be used to create a combination. Yet another example of a combination is a combination of element character cards have sequential atomic numbers. Yet another example of combinations are the combination of elements that are listed by actual chemical formulas. For example, the formula, H2O, if a player has a hydrogen card and oxygen card, the use of those cards along with a mole card could create H2O.

The use of the above embodiments of rules is merely illustrative and is not meant to be limiting. Those skilled in the art will recognize that additional rules can be employed while still satisfying the purpose of the inventive game and method. Futher, the above embodiments of the rules are shown as individual sets of rules. This is illustrative and not meant to be limiting. Those skilled in the art will recognize that the above embodiments of the rules can be combined together and with other sets of rules.

### INDUSTRIAL APPLICABILITY

The present invention applies industrially to educational methods and systems, particularly educational methods for teaching chemistry and the periodic table. More particularly, the present invention applies industrially to implementations that combine educational methods for teaching chemistry and the periodic table as combined with role playing games and devices.

What is claimed is:

1. An educational card battle game for teaching the periodic table of elements comprising, in combination:
a plurality of element character cards, wherein each element character card includes a drawing of a character that represents one element of the periodic table and incorporating actual data relating to the specific periodic table element thereon.

2. The educational card battle game of claim 1, wherein said actual data includes the periodic table element's atomic number and ionization potential.

3. The educational card battle game of claim 1, wherein said actual data includes a graphical representation of the group affiliation for the periodic table element represented by each element character card.

4. The educational card battle game of claim 1, wherein said actual data includes a graphical representation of the actual phase of matter at specific temperature settings for the periodic table element represented by each element character card, said actual phase of matter selected from the group consisting of solid, liquid and gas.

5. The educational card battle game of claim 1, further comprises:
a game board having a plurality of card spaces for placing one or more element character cards during game play.

6. The educations card battle game of claim 5, wherein said card spaces on said game board being defined including at least one elemon start space, at least one mole discard pile space, at least one compound attack combo space, at least one triumphant element card space, at least one earned mole card space, at least one strategic play set space, at least one liberated elemon space, and at least one mole play space.

7. The educational card battle game of claim 1, further comprises:
a randomizer to introduce an element of chance into game play.

8. The educational card battle game of claim 7, wherein said randomizer is selected from the group consisting of coins, dice, or cards alone or in combination.

9. The educational card battle game of claim 1, further comprises:
a plurality of mole cards, wherein each card having specific game play instructions.

10. The educational card battle game of claim 1 wherein each of said plurality of element character cards is defined as having a character display region to depict a figure representing a character and a character attribute region to depict the attributes associated with the character, wherein the attributes incorporate said actual data therein.

11. The educational card battle game of claim 10, wherein said actual data includes the periodic table element's atomic number and ionization potential.

12. The educational card battle game of claim 10, further comprises:
a game board having a plurality of card spaces for placing one or more element character cards during game play.

13. The educational card battle game of claim 10, further comprises:
a randomizer to introduce an element of chance into game play.

14. The educational card battle game of claim 13, wherein said randomizer is selected from the group consisting of coins, dice, or cards alone or in combination.

15. A method for playing an educational card battle game for teaching the periodic table of elements, said method comprising the steps of:
providing a plurality of element character cards, each element character card includes a drawing of a character that represents one element of the periodic table representing an element of the periodic table and incorporating actual data relating to the specific periodic table element thereon;
each player receiving a predetermined number of said element character cards;
comparing one of said element character cards for each player based on a set of rules to determine which card triumphs over the remaining cards, wherein said actual data is utilized by said rules in a realistic manner;
discarding all non-triumphant cards; and
repeating said comparing and discarding steps for all cards.

16. The method for playing an education card battle game of claim 15, wherein said actual data includes a graphical representation of the actual phase of matter at specific temperature settings for the periodic table element represented by each element character card, said actual phase of matter selected from the group consisting of solid, liquid and gas, said rules comprising:
comparing the phase of matter at a specific temperature for each element character card played by each player to determine which card triumphs over the remaining cards, wherein gas triumphs over liquid, liquid triumphs over solid and solid
triumphs over gas.

17. The method for playing an education card battle game of claim 16, wherein liquid triumphs over gas, gas triumphs over solid and solid triumphs over liquid.

18. The method for playing an education card battle game of claim 15, wherein said phase of matter for two or more cards are the same, said rules comprising:
comparing the phase of matter at a second specific temperatures for each element character card played by each player to determine which card triumphs over the remaining cards, wherein gas triumphs over liquid, liquid triumphs over solid and solid triumphs over gas.

19. The method for playing an education card battle game of claim 18, wherein liquid triumphs over gas, gas triumphs over solid and solid triumphs over liquid.

20. The method for playing an education card battle game of claim 16, wherein said actual data includes the crystalline structure for the periodic table element represented by each element character card, wherein said phase of matter for two or more cards are the same, said rules comprising:
comparing the crystalline structure for each element character card played by each player to determine which card triumphs over the remaining cards.

21. The method for playing an education card battle game of claim 15, further comprising the steps of:
providing a plurality of mole cards to each player, wherein each mole cards having specific instructions thereon, wherein said set of rules provides that the instructions on each of said plurality of mole cards supersedes all prior conflicting rules.

22. The method for playing an education card battle game of claim 15, wherein said actual data includes the actual atomic number, ionization potential and valance for the periodic table element represented by each element character card, and each of said element character cards having a plurality of attack formulations and a plurality of defenses thereon, wherein the value for the ionization potential represents the injury points for the character displayed on each card, said rules comprising:
each player in turn employing one of said plurality of attack formulations of one of said player's plurality of element character cards to reduce the injury points from one element character card of the other player;
the opposing player utilizing a defense of one of said opposing player's element character cards to reduce the impact of said one of said plurality of attack formulations; and
repeating steps of employing one of said plurality of attack formulations and utilizing a defense until the injury points of one of said element character cards has been reduced to zero.

23. The method for playing an education card battle game of claim 22, wherein said step of employing one of said plurality of attack formulations comprises:
utilizing in combination at least one die and at least one coin to determine the power of said one of said plurality of attack formulations.

24. The method for playing an education card battle game of claim 22, wherein said step of utilizing a defense comprises:
utilizing at least one coin to determine the power of said one of said plurality of defenses.

25. The method for playing an education card battle game of claim 15, further comprising the steps of:
providing a plurality of mole cards to each player, wherein each mole cards having specific instructions thereon, wherein said set of rules provides that the instructions on each of said plurality of mole cards supersedes all prior conflicting rules.

26. The method for playing an education card battle game of claim 22, wherein the element character card having the lowest atomic number is the first card to be played.

27. The method for playing an education card battle game of claim 22, wherein said actual data includes a graphical representation of the group affiliation for the periodic table element represented by each element character card, wherein said step of employing one of said plurality of attack formulations comprises:
utilizing in combination said graphical representation of the group affiliation and at least one coin to determine the power of said one of said plurality of attack formulations.

28. The method for playing an education card battle game of claim 15, wherein said actual data includes the actual atomic number, ionization potential and valance for the periodic table element represented by each element character card, said rules comprising:
each player employing two or more of said player's plurality of element character cards to create a combination based on said actual data; and
repeating steps of employing two or more of said player's plurality of element character cards have been combined or until no other combinations can be created.

29. The method for playing an education card battle game of claim 28, wherein said step of employing two or more of said plurality of attack formulations comprises:
utilizing in combination at least one die and at least one coin to determine the power of said one of said plurality of attack formulations.
